(19) United States
(12) Patent Application Publication
(10) Pub. No.: US 2006/0289837 A1
(43) Pub. Date: Dec. 28, 2006

(54) Silver salts of dicarboxcylic acids for precious metal powder and flakes

(76) Inventors: Kirk McNeilly, North Scituate, RI (US); Brian LaCroix, Attleboro, MA (US); Harry Richard Kuder, Fullerton, CA (US)

Correspondence Address: NIXON PEABODY, LLP, 401 9TH STREET, NW, SUITE 900, WASHINGTON, DC, 20004-2128, US

(21) Appl. No.: 11/159,336

(22) Filed: Jun. 23, 2005

(51) Int. Cl. H01B 1/12

(52) U.S. Cl. 252/500

(57) ABSTRACT

Noble metal (e.g., silver) powder and/or flake is at least partially coated with a silver salt lubricant, and is prepared by milling a noble metal powder (e.g., silver) in the presence of a silver salt of dicarboxylic acid lubricant.

### RELATED APPLICATIONS

The present invention is related to U.S. patent application Ser. No. ______ entitled “Metal Salts of Organic Acids as Conductivity Promoters” filed on Jun. 23, 2005.

### BACKGROUND OF THE INVENTION

1. Field of the Invention

The present invention relates to a noble metal (e.g., silver) powder and/or flake at least partially coated with a silver salt lubricant, and more particularly, to a method of forming a noble metal flake by milling a noble metal powder (e.g., silver) in the presence of an organic silver salt lubricant.

2. Description of Related Art

Using silver salt of stearic acid to produce silver flake for use in silver-filled glass pastes for bonding semi-conductive devices and components has resulted in improved dispensing and adhesion. See U.S. Pat. No. 4,859,241. Dispersion and adhesion has been further improved by coating a noble powder or flake with a thiol based lubricant. See U.S. Pat. No. 5,433,893, the disclosure of which being herein incorporated by reference.

Such conductive lubricated noble metal (e.g., gold) powder and/or noble metal flake (or a combination of the two) are at least partially coated with a thiol lubricant. The thiol lubricant comprises a long-chain aliphatic thiol with a chain length of at least ten carbons, preferably in the range from dodecylthiol to tetracosylthiol, most preferably decaoctyl thiol.

It has been shown that replacing a long chain fatty acid with short chain fatty acids improves conductivity. See “Development of Isotropic Conductivity Adhesives with Improved Conductivity,” Yi Li, Kyoung-sik Moon, Haiying Li and C. P. Wong, 9^{th} Int'l Symposium on Advanced Packaging Materials, 2004. Also, by replacing the long chain fatty acid with short chain fatty dicarboxylic acids the viscosity of the adhesive was increased. This is a fundamental problem since the end uses require lower viscosities in order so that dispensing speed can be increased. The method described by Li et al. to replace the acids is time consuming and incurs additional costs. Moreover, the short chain dicarboxylic acida are poor lubricants because they do not adequately prevent cold welding of the silver particles. The silver flakes manufactured with short chain dicarboxylic acids have much larger particle sizes and this limits their ability to be used in many applications.

The present invention rectifies the prior art deficiencies with the use of silver salts of dicarboxylic acids that prevent cold welding and allow for silver flakes and powder to be produced with the correct particle size distributions.

### SUMMARY OF THE INVENTION

It is an object of the present invention to mill noble metal particles (e.g., gold powder or flakes) at least partially coated with a silver salts of dicarboxcylic acid lubricants.

It is another object of the present invention to provide noble metal particles with improved disbursement properties.

In achieving these and other objects, there is provided conductive lubricated silver particles at least partially coated with a silver salts of dicarboxcylic acids lubricant.

These and other objects, features, aspects, and advantages of the present invention will become more apparent from the following detailed description of the preferred embodiment.

### DESCRIPTION OF THE PREFERRED EMBODIMENT

The present invention relates to noble metal fillers, which may be blended into a binder of an inorganic, fusible glass.

Filler particles may be in powder, flake, or other form. Flakes are capable of yielding finished features of desirably low bulk resistivity and high coverage (surface area covered per unit weight of flakes).

Flakes (aspect ratio greater than one and typically six or higher) may be formed from powders (aspect ratio of about one; i.e., essentially spherical) by mechanically milling in, e.g., a ball mill. The metal is generally wet milled, in a solvent/lubricant vehicle, to prevent cold welding and formation of overly large flakes. Conventional milling vehicles include fatty acid lubricants dissolved or suspended in water, alcohol, aliphatic solvents, ketones, or glycols.

In the case of silver, fatty acid lubricants have a sufficiently strong chemisorption bond to the surface of the silver particles to keep them separated during milling.

The present invention features a method of making a nobel metal powder or flake by milling a noble metal powder (e.g., silver) in the presence of a silver salt of a dicarboxcylic acid lubricant.

Preferred embodiments include the following features. The silver salt of a dicarboxcylic acid lubricant comprises of a chain length of at least two carbons, preferably in the range from 4 to 10 carbon atoms, most preferably silver salt of a suberic acid. The lubricant has coverage of 3 to 200 milligrams per square meter. The ratio by weight of lubricant to silver is in the range of 1:10 to 1:200.

The lubricated noble metal powder or noble metal flake has an aspect ratio larger than one; a mean flake size of from 0.5 to 20 microns in the longest dimension; surface areas in the range of 0.1 to 3.0 square meters per gram; and a TAP density of at least about 1.0, preferably at least 3.0 g/cc.

The silver salt of a dicarboxcylic acid lubricant is dispersed in an organic solvent, preferably isopropyl alcohol. The ratio by weight of silver salt of a dicarboxcylic acid lubricant to organic solvent is in the range of 1:10 to 1:100. The milling proceeds for a period of from 1 to 4 hours. The ratio by weight of lubricant to silver is in the range of 1:10 to 1:1000. The ratio by weight of lubricant to solvent is in the range of 1:1 to 1:400. The ratio by weight of solvent to noble metal is in the range of 1:4 to 10:1.

Advantages of the present invention are that the silver salt of a dicarboxcylic acid is a superior lubricant when compared to the free acid version. When the silver salt of a dicarboxcylic acid is used a silver flake can be produced with a smaller and narrow particle size distribution.

Before proceeding to additional description and examples, the following terms should be defined:

Noble metal powder is a particulate material that has not gone through a mechanical or milling process and is not coated with a lubricant.

Lubricated noble metal powder is a noble metal powder whose surface is coated with a lubricant.

Noble metal flake is a material that typically has gone through a mechanical or milling process in the presence of a lubricant, retains a coating of the lubricant, and has an aspect ratio greater than one, i.e., the ratio of the widest dimension of a typical particle to the smallest dimension of that particle.

Particle size is the mean particle size as measured by a particle size analyzer such as the Malvern Mastersizer Particle Analyzer.

Conductivity refers to electrical as well as thermal conductivity.

Milling is an intensive mixing process capable of breaking up particulate agglomerates, dispersing a lubricant uniformly on a suspended powder, or flattening or otherwise deforming particles or agglomerates.

TAP density is mass per unit volume measured after performing a number of taps to a cylindrical column of powder using an instrument such as a Tap-Pak volumeter. All TAP densities reported were determined by ASTM method B527-85.

Thixotropic index is the ratio of viscosity at a shear rate of 1.92/sec to the viscosity at a shear rate of 19.2/second.

Viscosities are given at a shear rate of 19.2/second (5 rpm) on a Brookfield HBT cone/plate viscometer (spindle CP-51). Viscosities are expressed in units of centipoise (cPs).

Adsorption is the condensation of gases, liquids or dissolved substances on a solid surface.

In the present invention, noble metal flake is formed by milling noble metal powder in the presence of a silver salt of a dicarboxcylic acid lubricant. The resulting silver salt of dicarboxcylic acid coated flake (of the silver salt of a dicarboxcylic acid lubricated noble metal powder) is mixed with an inorganic, fusible glass binder to make a liquid or paste.

The liquid or paste, after firing, preferably has a volume resistivity of less than 0.1 ohm-cm. Lower volume resistivities can be achieved by prolonging the firing time at higher temperatures or by increasing the weight content of silver in the paste. Low volume resistivities are achieved in inorganic systems with binders such as high lead borate glass frit. These systems have the additional advantage of high temperature resistance.

The term silver salt of a dicarboxcylic acid refers to organic compounds which include an —COO⁻Ag⁺ group, also known as Silver carboxylate.

Among these, aliphatic silver salt of a dicarboxcylic acids are preferred, preferably those having a chain length of 3 carbon atoms or more. Preferred silver salt of a dicarboxcylic acid lubricants range from silver salt of malonic acid to silver salt of a Sebacic acid:
R—(COOH)₂
where R═C₃H₆ through C₁₂H₂₄ A particularly preferred silver salt of a dicarboxcylic acid is silver salt of a Suberic acid. Lubricants are usually strongly adsorbed or chemisorbed with energies in excess of 50 kJ/mol.

Solubility of the lubricant in the solvent is not a prerequisite and consequently many organic and inorganic solvents such as alcohols, ketones and water are suitable. The lubricant is preferably dispersed in an organic solvent, preferably isopropyl alcohol, in a weight ratio of from about 1:1 to 1:400.

Most commercially available silver powders are suitable for use in the invention. Preferred powders have a surface area of 0.1 to 1.3 m²/g and a mean particle size of 0.5 to 10 micron. The TAP density should be greater than 0.6 g/cm³, preferably greater than 0.9 g/cm³. Preferred powders include silver powders available from Metalor such as D-0001.

The silver flake is preferably produced by wet milling the silver powder in the lubricant solution, using from about 5 to 50 ml. solution per 100 grams silver powder. The powder is preferably milled in the solution for 1-4 hours and the temperature of the powder and solution maintained at room temperature or below. The temperature of the powder is controlled by providing the mill with a cooling jacket. Wet milling may be accomplished by a ball or attritor mill, typically containing a number of steel balls although glass or ceramic balls will give similar results. For a 1 liter Union Process attritor mill, the preferred rotation speed is from about 300 to 600 rpm. The milling may be performed with other types of mixers, including radial or axial type stirrer, high speed homogenizer, ultrasonic disperser or jet mills.

After milling, the silver in flake form is rinsed to separate it from the milling media, e.g. with organic solvents (such as acetone, ethanol, MEK, ethyl acetate, etc.), dried, and screened to a desired maximum particle size.

The results are summarized in the following chart:

Summary of Experiments:

| | | Tap | Surface | Weight | mg | Particle Size Distribution (Malvern) | | | | |
|---|---|---|---|---|---|---|---|---|---|---|
| | Lubricant | Density | Area | Loss @ | fatty | PSD | PSD | PSD | PSD | PSD |
| Product Type | Type | (g/cc) | (m²/g) | 538° C. | acid/m² | 100 | 90 | 50 | 10 | MV |
| 02-P 315- 25-LAB | Stearic Acid | 4.64 | 0.50 | 0.26% | 5.20 | 30.2 | 13.6 | 6 | 2 | 7 |
| 02-P 315- 26-LAB | Adipic Acid | 4.39 | 0.45 | 0.25% | 5.56 | 69.2 | 19.8 | 7.2 | 2.2 | 9.5 |
| 02-P 315- 30-LAB | Silver Adipate | 4.00 | 0.90 | 0.79% | 8.78 | 30.2 | 12.8 | 5.3 | 1.6 | 6.4 |
| 02-P 315- 28-LAB | Suberic Acid | 4.04 | 0.50 | 0.14% | 2.80 | 91.2 | 20.7 | 7.1 | 2.2 | 10 |
| 02-P 315- 32-LAB | Ag Suberate | 4.10 | 1.09 | 1.03% | 9.45 | 34.7 | 14.2 | 5.8 | 1.6 | 7 |
| 02-P 315- 29-LAB | Sebacic Acid | 3.68 | 0.46 | 0.31% | 6.74 | 79.4 | 16.5 | 6.4 | 2 | 8.2 |
| 02-P 315- 33-LAB | Silver Sebacate | 4.06 | 0.95 | 0.83% | 8.74 | 30.2 | 13.2 | 5.4 | 1.6 | 6.6 |

| | | | | | | Viscosity | | |
|---|---|---|---|---|---|---|---|---|
| | | | | Cure | Cure | @ a shear | | Volume |
| | Lubricant | Resin | Percent | Time | Temp. | rate of | Thixotropic | Resistivity |
| Product Type | Type | Type | loading | (min) | (° C.) | 1.92 sec⁻¹ | Index | (ohm-cm) |
| 02-P 315- 25-LAB | Stearic Acid | TV-062A | 75 | 60 | 175 | 9093 | 5.14 | >1000 |
| 02-P 315- 26-LAB | Adipic Acid | TV-062A | 75 | 60 | 175 | 7619 | 2.69 | >1000 |
| 02-P 315- 30-LAB | Silver Adipate | TV-062A | 75 | 60 | 175 | 10404 | 3.7 | 2.2 × 10⁻² |
| 02-P 315- 28-LAB | Suberic Acid | TV-062A | 77.6 | 60 | 175 | 0 | 0 | >1000 |
| 02-P 315- 32-LAB | Ag Suberate | TV-062A | 75 | 60 | 175 | 11796 | 5.42 | 2 × 10⁻⁴ |
| 02-P 315- 29-LAB | Sebacic Acid | TV-062A | 75 | 60 | 175 | 12943 | 3.1 | >1000 |
| 02-P 315- 33-LAB | Silver Sebacate | TV-062A | 75 | 60 | 175 | 9339 | 4.12 | 0.1 |

### EXAMPLE I

A coated noble metal was formed from the following mixture:

| | | |
|---|---|---|
| 2.3 micron silver powder (Metalor D-0001) | 1680 | grams |
| 1 micron powder (C-2461P) | 358 | grams |
| Adipic acid | 17 | grams |
| isopropyl alcohol | 250 | ml. |

The constituents were added to a suitably sized attritor mill containing 4043 grams steel balls ( 3/32″ diameter). The silver powder was milled at 15° C. at a speed of 600 rpm for 225 minutes with coolant delivered through ajacket. After milling, the silver flake was washed free of the milling media with several acetone washes. The moist powder was vacuum dried and then screened through a 325 mesh screen. The resultant powder had a TAP density of 4.4 g/cm³, a maximum particle size of 69.2 microns, and a mean particle size of 9.5 microns. When mixed into a binder, the maximum loading obtained was 75% silver powder. The viscosity of the paste was 7619 centipoise with a thixotropic index of 2.7. After curing at 175° C. for one hour, a 2 mil layer of ink yielded a volume resistivity greater than 1000 ohm-cm.

### EXAMPLE II

A coated noble metal was formed from the following mixture:

| | | |
|---|---|---|
| 2.3 micron silver powder (Metalor D-0001) | 1680 | grams |
| 1 micron powder (C-2461P) | 358 | grams |
| Silver salt of Adipic acid | 33.6 | grams |
| isopropyl alcohol | 300 | ml. |

The constituents were added to a suitably sized attritor mill containing 4043 grams steel balls ( 3/32″ diameter). The silver powder was milled at 15° C. at a speed of 600 rpm for 225 minutes with coolant delivered through a jacket. After milling, the silver flake was washed free of the milling media with several acetone washes. The moist powder was vacuum dried and then screened through a 325 mesh screen. The resultant powder had a TAP density of 4.0 g/cm³, a maximum particle size of 30.2 microns, and a mean particle size of 6.4 microns. When mixed into a binder, the maximum loading obtained was 75% silver powder. The viscosity of the paste was 10404 centipoise with a thixotropic index of 3.7. After curing at 175° C. for one hour, a 2 mil layer of ink yielded a volume resistivity of 0.0220 ohm-cm.

### EXAMPLE III

A coated noble metal was formed from the following mixture:

| | | |
|---|---|---|
| 2.3 micron silver powder (Metalor D-0001) | 1680 | grams |
| 1 micron powder (C-2461P) | 358 | grams |
| Suberic acid | 17 | grams |
| isopropyl alcohol | 250 | ml. |

The constituents were added to a suitably sized attritor mill containing 4043 grams steel balls ( 3/32″ diameter). The silver powder was milled at 15° C. at a speed of 600 rpm for 225 minutes with coolant delivered through a jacket. After milling, the silver flake was washed free of the milling media with several acetone washes. The moist powder was vacuum dried and then screened through a 325 mesh screen. The resultant powder had a TAP density of 4.0 g/cm³, a maximum particle size of 91.2 microns, and a mean particle size of 10 microns. When mixed into a binder, the maximum loading obtained was 75% silver powder. The viscosity of the paste was 9585 centipoise, with a thixotropic index of 2.4. After curing at 175° C. for one hour, a 2 mil layer of ink yielded a volume resistivity greater than 1000 ohm-cm.

### EXAMPLE IV

A coated noble metal was formed from the following mixture:

| | | |
|---|---|---|
| 2.3 micron silver powder (Metalor D-0001) | 1680 | grams |
| 1 micron powder (C-2461P) | 358 | grams |
| Silver salt of suberic acid | 33.6 | grams |
| isopropyl alcohol | 300 | ml. |

The constituents were added to a suitably sized attritor mill containing 4043 grams steel balls ( 3/32″ diameter). The silver powder was milled at 15° C. at a speed of 600 rpm for 225 minutes with coolant delivered through a jacket. After milling, the silver flake was washed free of the milling media with several acetone washes. The moist powder was vacuum dried and then screened through a 325 mesh screen. The resultant powder had a TAP density of 4.1 g/cm³, a maximum particle size of 34.7 microns, and a mean particle size of 7 microns. When mixed into a binder, the maximum loading obtained was 75% silver powder. The viscosity of the paste was 11796 centipoise with a thixotropic index of 5.4. After curing at 175° C. for one hour, a 2 mil layer of ink yielded a volume resistivity of 0.0002 ohm-cm.

### EXAMPLE V

A coated noble metal was formed from the following mixture:

| | | |
|---|---|---|
| 2.3 micron silver powder (Metalor D-0001) | 1680 | grams |
| 1 micron powder (C-2461P) | 358 | grams |
| Sebacic acid | 17 | grams |
| Isopropyl alcohol | 300 | ml. |

The constituents were added to a suitably sized attritor mill containing 4043 grams steel balls ( 3/32″ diameter). The silver powder was milled at 15° C. at a speed of 600 rpm for 225 minutes with coolant delivered through a jacket. After milling, the silver flake was washed free of the milling media with several acetone washes. The moist powder was vacuum dried and then screened through a 325 mesh screen. The resultant powder had a TAP density of 3.7 g/cm³, a maximum particle size of 79.4 microns, and a mean particle size of 8.2 microns. When mixed into a binder, the maximum loading obtained was 75% silver powder. The viscosity of the paste was 12943 centipoise with a thixotropic index of 3.1. After curing at 175° C. for one hour, a 2 mil layer of ink yielded a volume resistivity greater than 1000 ohm-cm.

### EXAMPLE VI

A coated noble metal was formed from the following mixture:

| | | |
|---|---|---|
| 2.3 micron silver powder (Metalor D-0001) | 1680 | grams |
| 1 micron powder (C-2461P) | 363 | grams |
| Silver salt of Sebacic acid | 33 | grams |
| isopropyl alcohol | 300 | ml. |

The constituents were added to a suitably sized attritor mill containing 4043 grams steel balls ( 3/32″ diameter). The silver powder was milled at 15° C. at a speed of 600 rpm for 225 minutes with coolant delivered through a jacket. After milling, the silver flake was washed free of the milling media with several acetone washes. The moist powder was vacuum dried and then screened through a 325 mesh screen. The resultant powder had a TAP density of 4.1 g/cm³, a maximum particle size of 30.2 microns, and a mean particle size of 6.6 microns. When mixed into a binder, the maximum loading obtained was 75% silver powder. The viscosity of the paste was 9339 centipoise with a thixotropic index of 4.1. After curing at 175° C. for one hour, a 2 mil layer of ink yielded a volume resistivity greater than 1000 ohm-cm.

Although the present invention has been described in relation to particular embodiments thereof, many other variations and modifications and other uses will become apparent to those skilled in the art. It is preferred therefore, that the present invention be limited not by the specific disclosure herein, but only by the appended claims.

What is claimed is:

1. Noble metal particles at least partially coated with a silver salt of dicarboxylic acid lubricant.

2. The noble metal particles of claim 1, wherein the noble metal particles are silver.

3. The noble metal particles of claim 2, wherein said silver salt of dicarboxcylic acid lubricant has a chain length of at least 3 carbons.

4. The noble metal particles of claim 2, wherein said silver salt of dicarboxcylic acid lubricant contains between 2 and 24 carbon atoms.

5. The noble metal particles of claim 2, wherein said silver salt of dicarboxcylic acid lubricant has a coverage of 3 to 200 milligrams per square meter.

6. The noble metal particles of claim 2, wherein the ratio by weight of lubricant to silver is in the range of 1:10 to 1:200.

7. The noble metal particles of claim 2, wherein said lubricated silver particles have an aspect ratio equal to or greater than one.

8. The noble metal particles of claim 2, wherein said lubricated silver particles have a mean particle size of about 0.5 to 40 microns in its longest dimension.

9. The noble metal particles of claim 2, wherein said lubricated silver particles have a surface area in the range of 0.05 to 3.0 square meters per gram.

10. The noble metal particles of claim 2, wherein said lubricated silver particles have a TAP density of at least 1.0 g/cm³.

11. The noble metal particles of claim 2, wherein said silver salt of dicarboxcylic acid lubricant comprises silver salt of suberic acid.

12. The noble metal particles of claim 1, wherein the noble metal particles are powder.

13. The noble metal particles of claim 12, wherein the noble metal powder has an aspect ratio of and about 1.

14. The noble metal particles of claim 1, wherein the noble metal particles are flakes.

15. The noble metal particles of claim 14, wherein the flakes have an aspect ratio greater than 1.

16. The noble metal particles of claim 14, wherein the flakes have an aspect ratio greater than 6.

17. The noble metal particles of claim 1, wherein the noble metal particles are a combination of powder and flakes.

18. The noble metal particles of claim 1, wherein the dicarboxylic acids includes malonic; succinate; adipic; suberic; sebacic; acrylic or stearic acid.

19. The noble metal particles of claim 1 contained in an inorganic, fusible glass binder.

20. A method of making noble metal particles comprising the step of milling noble metal particles in the presence of a silver salt of a dicarboxcylic acid lubricant.

21. The method of claim 20, wherein the noble metal particles comprise a silver powder.

22. The method of claim of claim 21, wherein the silver salt of dicarboxcylic acid lubricant is dispersed in an organic solvent.

23. The method of claim 22, wherein the solvent comprises an alcohol.

24. The method of claim 22, wherein the ratio by weight of silver salt of dicarboxcylic acid lubricant to organic solvent is in the range of 1:10 to 1:500.

25. The method of claim 22, wherein the milling step lasts for a time period of about 1 to 8 hours.

26. The method of claim 22, wherein the ratio by weight of lubricant to silver is in the range of 1:10 to 1:200.

27. The method of claim 22, wherein the ratio by weight of lubricant to silver is in the range of 1:1 to 1:400.

28. The method of claim 22, wherein the ratio by weight of solvent to silver is in the range of 1:4 to 10:1.

29. The method of claim 20, further comprising the step of mixing the milled noble metal particles with an inorganic fusible glass binder to form a liquid or paste.

30. The method of claim 21, further comprising the step of mixing the milled silver with a binder to form a liquid or paste.
